(19) United States
(12) Patent Application Publication
(10) Pub. No.: US 2001/0037364 A1
(43) Pub. Date: Nov. 1, 2001

(54) Management of enterprise communications

(76) Inventors: Nancy R. Michalek, Plano, TX (US); Saundre K. Henderson, Plano, TX (US); Neil A. Jarvis, Frisco, TX (US); David A. Yates, Valley View (AU); Cynthia S. Fertenbaugh, Concord, NC (US); Margaret J. Joachim, London (GB); James C. Erbelding, Webster, NY (US); Betsy M. Mester, Plano, TX (US)

Correspondence Address: David G. Wille, Esq., Baker Botts L.L.P., Suite 600, 2001 Ross Avenue, Dallas, TX, 75201-2980, US

(21) Appl. No.: 09/799,740

(22) Filed: Mar. 5, 2001

Related U.S. Application Data
(60) Provisional application No. 60/203,007, filed on May 10, 2000.

(51) Int. Cl. G06F 15/16

(52) U.S. Cl. 709/204; 709/206

(57) ABSTRACT

One aspect of the invention is a method for managing an enterprise's communications. A plurality of issues is identified on which to manage communications. For each of the plurality of issues, a communications list is created comprising at least one person that is to be informed of an issue. For at least one of the plurality of issues, the communications list is organized hierarchically. For at least one of the plurality of issues, criterion is established as to when information about the at least one of the plurality of issues should be communicated to a level higher, lower, or across the hierarchy of the communications list.

### RELATED APPLICATION

This application claims the benefit of U.S. Provisional Application Ser. No. 60/203,007, filed May 10, 2000, entitled “Organized Enterprise Communications”.

### TECHNICAL FIELD OF THE INVENTION

This invention relates generally to communications and more particularly to a method for managing an enterprise's communications.

### BACKGROUND OF THE INVENTION

Effective and efficient communications are important for many different types of enterprises. The term “enterprise” herein refers broadly to a group of persons joined together for some purpose. It may include organizations, partnerships, businesses, non-profit organizations, government agencies, professional organizations, or corporations, for example. A single enterprise may also include customers and suppliers of a business combined with the business itself as well as other persons having some relationship to the business. Disorganized communication processes in an enterprise may create inefficiencies that can have a deleterious effect on the operation of a business or other organization. In most enterprises, communications are handled in a disorganized fashion rather than according to a structured plan.

For example, when a problem arises, a person who discovers the problem may report it by guessing as to who is responsible to solve the problem. That person may also have to talk to numerous people who cannot help solve the problem. The person who is responsible for solving the problem may have little guidance as to what problems to share with superiors.

Communication problems are magnified when an enterprise has multiple locations and may be spread over a wide geographical area. Different working hours interfere with communications. Local customs as to communications may cause inconsistent communication habits among parts of large enterprises. Communication problems are also magnified where the enterprise comprises two or more merged businesses that may have operated in different ways in the past before merger. When merger of two organizations occurs, communications within the merged enterprise may be difficult and create inefficiencies.

### SUMMARY OF THE INVENTION

One aspect of the invention is a method for managing an enterprise's communications. A plurality of issues is identified on which to manage communications. For each of the plurality of issues, a communications list is created comprising at least one person that is to be informed of an issue. For at least one of the plurality of issues, the communications list is organized hierarchically. For at least one of the plurality of issues, criterion is established as to when information about the at least one of the plurality of issues should be communicated to a level higher, lower, or across the hierarchy of the communications list.

The invention has several important technical advantages. Various embodiments of the invention may have none, one, some, or all of these advantages without departing from the scope of the invention. The invention allows structured management of communications about issues affecting an enterprise. The invention may facilitate efficient communications among enterprises spread out over wide geographic regions and among disparate organizations, although it is also useful for organizations operating on a local, regional, or national scale. The invention may allow a rapid response to an issue facing an enterprise. The invention may allow identification of actions to be taken in response to various issues so as to minimize decision making at the time of an occurrence. Thus, the invention allows an enterprise to respond to occurrences rapidly and correctly. The invention further improves communications because persons in an enterprise receiving communications view those communications as coming from an authorized source. The structured communications provided by the invention also allow an enterprise to move critical information needed for decision making to the appropriate levels of the organization to facilitate rapid and efficient decision making.

### BRIEF DESCRIPTION OF THE DRAWINGS

For a more complete understanding of the present invention and the advantages thereof, reference is now made to the following descriptions taken in conjunction with the accompanying drawings in which:

FIG. 1 illustrates a flow chart of a method for managing an enterprise's communications in accordance with the present invention;

FIG. 2 illustrates a block diagram of an example of a communications hierarchy that may be created in connection with the management of an enterprise's communication; and

FIG. 3 illustrates a flow chart of a method for communicating about an issue using the organized communications method of the invention.

### DETAILED DESCRIPTION OF THE INVENTION

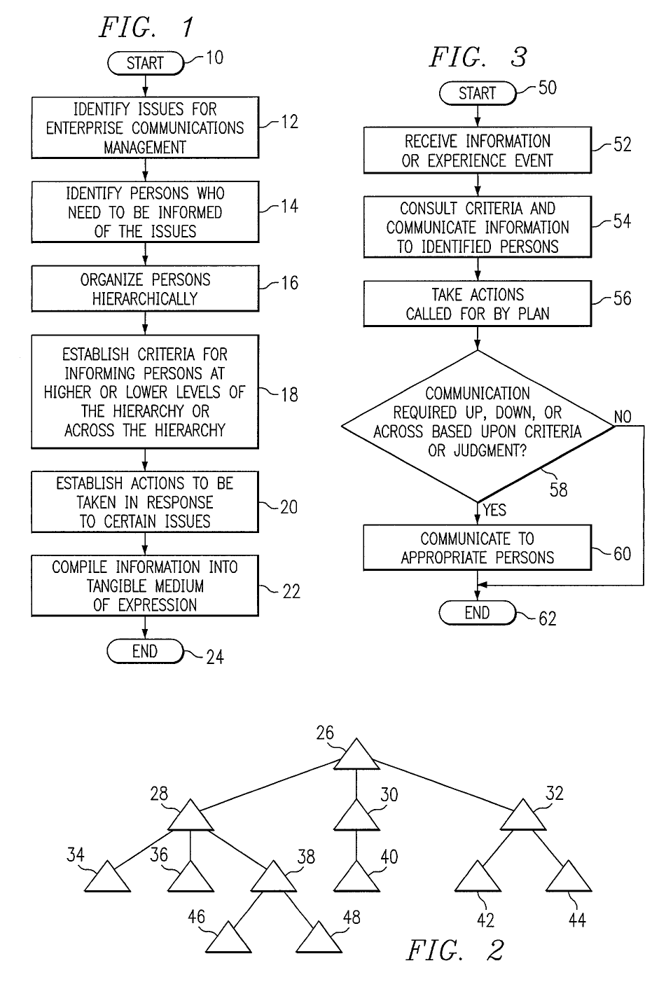

The preferred embodiment of the present invention and its advantages are best understood by referring to FIGS. 1-3 of the drawings, like numerals being used for like and corresponding parts of the various drawings.

FIG. 1 illustrates a flow chart describing a method for managing an enterprise's communications in accordance with one embodiment of present invention. The invention allows structured communications about various issues that may affect an enterprise. The term “issue” may refer broadly to any subject upon which an enterprise desires effective communications. Without limiting the generality of the foregoing, issues may include events or occurrences that an enterprise desires to provide an efficient response to, the identification of persons with relevant knowledge or expertise, or the status of various systems or processes within the corporation. More specific examples of the usefulness of the communications method will be discussed below. However, the communications method may be used for communications about any issue.

When an enterprise has made a decision to manage communications about issues that affect it, it may begin the method in step 10. In step 12, issues are identified for enterprise communications management. Although any issue may be managed using the communications method of the invention, examples of issues that an enterprise may want to manage include crises responses, implementation of new business processes, implementation of new enterprise procedures, implementation of new systems and equipment, the monitoring of the status of an enterprise, the monitoring of a project within the enterprise, the monitoring of equipment and systems, the locating of personnel with proper expertise, etc.

Next, in step 14 a list of persons who need to be informed of various issues is created. This list may include a range of persons that may need to be informed about a particular issue but do not necessarily have to be informed about an issue in every case. Where the issue involves status information, the person who needs to provide the information may also be identified. The persons who need to be informed of an issue may be persons both within and external to an enterprise. For example, where the enterprise is a business, suppliers or customers may need to be on the list of persons who need to be identified in certain circumstances with respect to particular issues. The list of persons that need to be informed of an issue may include persons who need to be aware of an issue, those who control information pertaining to the issue, those responsible for maintaining the information, those people affected by an issue and/or those persons responsible for making a decision based upon information related to the issue.

In step 16, the list of persons is organized hierarchically. Normally, an enterprise has some type of hierarchical organization. Generally, less important issues tend to be handled at lower levels of the hierarchy while more important issues tend to handled at a higher level of the hierarchy. As issues that are apparently less important become more important, those issues may be communicated to higher levels of the hierarchy. Although, any type of hierarchical organization may be used to suit the particular enterprise, one type of hierarchy will be discussed in connection with FIG. 2. A single hierarchy may be created to address all of the issues on which structured communications is desired. Alternatively, different hierarchies may be created for each issue or for a group of issues. Although an enterprise's organizational hierarchy may be used as the hierarchy for communications, it does not have to be. A different hierarchy can be created for communications purposes. For example, a corporation may be organized into various departments with various layers of management. This hierarchy could be adopted for the communications method or a separate hierarchy could be created that is different from the corporate organizational hierarchy.

In step 18, criteria are established for informing persons at higher or lower levels of the hierarchy or across the hierarchy. The term “across the hierarchy” is meant broadly to refer to communications to another part of the hierarchy that is not in a branch of the hierarchy that a person or group of persons either reports to directly or indirectly (i.e., those higher up in the hierarchy) or that reports to it either directly or indirectly (i.e., those lower in the hierarchy). For example, node 36 in FIG. 2 communicates across the hierarchy when it communicates with nodes 34, 38, 46, 48, 30, 40, 32, 42 and 44. In some cases, information should be communicated to a higher level of the hierarchy. As issues grow in significance, they may be communicated to higher levels in the hierarchy to allow those responsible for dealing with more significant issues to learn of the required information. In some cases, information may be disseminated to lower levels of the hierarchy such as for informational purposes or to allow those at a lower level of the hierarchy to deal with less significant issues. An enterprise may desire information to be communicated across the hierarchy where an issue may effect multiple groups within the hierarchy that are within different branches of the hierarchy. There are a variety of reasons why information may be desirably communicated to a higher or lower level of the hierarchy or across the hierarchy and the invention is not limited to particular criterion. The criterion may or may not require human judgment as to whether the information should be communicated. Where human judgment is employed, the criterion may specify various factors to consider in exercising that judgment.

In step 20, actions to be taken in response to certain issues may be established. Alternatively, this step may be omitted without departing from the scope of the invention. To handle issues efficiently, the enterprise may wish to identify standard actions to be taken when certain issues occur. In addition, the list of actions to be taken may also define how information is reported within the hierarchy. For example, where the criteria for informing persons at a higher or lower level of the hierarchy or across the hierarchy indicates that a communication should occur, the actions to be taken may predefine all items of information that should be reported, those that should not be reported, and the frequency of reporting. Although some information will only be communicated once, some information may be reported periodically such as when status monitoring is occurring using the invention. Status monitoring can be used to monitor the status of anything, such as for example, whether machines are operating or not, the status of computer systems, the current state of an assembly line, the location of delivery vehicles, etc. The actions to be taken may also define information that needs to be collected before communication can occur and who that information can be obtained from and how that information may be obtained. By defining these types of actions, information may be distributed to a variety of recipients either inside or external to an enterprise in an accurate, concise, consistent and timely manner.

In some cases, the actions to be taken in response to certain issues may include immediate communications about a particular issue. The list of actions may specify a desired type of communications and/or a list of alternative methods of communicating about the issue. Example methods of communication may include electronic mail, teleconferences, video conferences, fax communications, cameras mounted to computers, and any other method of communicating among multiple persons in multiple locations.

In step 22, the information that has been collected in connection with the method illustrated in FIG. 1 is compiled into a tangible medium of expression. Such information may be stored on a computer and may be indexed to allow all persons within an enterprise, as well as persons outside the enterprise that engage in transactions with the enterprise, to access the communications plan when needed. Alternatively, such information may be compiled in any other medium such as paper, microfilm, or microfiche. The method then ends at step 24. Information collected in connection with the method illustrated in FIG. 1 can also be compiled into a tangible medium of expression at any point in the process. Information can be collected gradually and recorded over a long period of time. The method of FIG. 1 may be repeated continuously over long periods of time as well as new issues arise that warrant structured communications.

FIG. 2 illustrates an example of a type of hierarchy that may be used in connection with the present invention. The hierarchy in FIG. 2 is a tree-like hierarchy. The tree-like hierarchy in FIG. 2 has a plurality of nodes 26-48. As can be seen, each level of the hierarchy may have any number of nodes within it. In addition, each node may have any number of nodes branching off of it. In this embodiment, each node 26-48 comprises a person or group of persons. As noted above, the hierarchy may be organized similarly to the general organization of the enterprise or may be organized differently. In addition, the hierarchy may include persons outside of a business where desired.

An example will be used to illustrate how the hierarchy of FIG. 2 may be used to efficiently communicate about an issue in accordance with the invention. A person in node 32 may receive information about an issue that he knows ought to be communicated. After consulting the communications plan, the person in node 32 learns that the issue should be communicated to someone in node 46. Thus, the person in node 32 communicates across the hierarchy to a person or persons within node 46. Upon receiving notice of the issue, the person or persons in node 46 may consult the criteria and actions to be taken to identify actions to be taken in response to the issue and to allow a determination of whether the information should be communicated to a higher level of the hierarchy. If communications to a higher level of the hierarchy are required, then a person in node 46 may communicate to a person or persons in node 38 about the issue. This process may repeat itself with node 38 reporting to node 28 and node 28 reporting to node 26.

At some point, the resolution of the issue or the handling of the issue may also require communication of information back down to lower levels of the hierarchy. For example, while handling the issue, node 28 could communicate back down to nodes 38, 46 and 48, or could even communicate to nodes 34, 36, and 38. Persons in node 28 may also determine that proper people to solve the problem are in node 42 and may communicate across the hierarchy to solve the problem. Where the enterprise stretches across different time zones, persons in node 28 might communicate an unsolved problem to node 32 in a different time zone near the end of a business day so that the problem could be addressed continuously by the enterprise, while allowing individual persons in the enterprise to sleep. As conditions change, the communications plan may require further communications to levels higher, lower, or across the hierarchy.

In one embodiment of the invention, some or all of the nodes in the communications hierarchy illustrated in FIG. 2 may be issues management centers. Where major events occur within an enterprise, such as the rolling out of a new product, the implementation of new business processes, or the handling of unusual events, it may be desirable to have issues management centers to provide fast, efficient responses to problems that are likely to occur. Such a center may include equipment for facilitating communications with people in a wide range of locations such as computers with electronic mail access, teleconferencing equipment, video conferencing equipment, telephones, fax machines, and cameras connected to computers. In many cases, the centers may be portable and may be set up and taken down quickly so that they are in the most desirable geographical location for dealing with a particular issue. Such centers may bring together key personnel within various nodes of the hierarchy so that the proper decision makers can resolve difficult problems quickly.

To facilitate communication among various nodes in the hierarchy illustrated in FIG. 2, group electronic mailboxes may be used. Each node may be assigned a group mail box. A person within a particular node may be assigned decision making responsibility for the node. That person would have control of the group mailbox. When that person was unavailable because they were off duty, on vacation, or otherwise, they may designate decision making responsibility to another member of the node within the hierarchy. This may allow more rapid communications as the group mailbox may receive more frequent monitoring. In an international organization, a particular node may include persons in various time zones around the world such that the group mailbox is managed at different points in the day by persons in different geographical regions and time zones. Again, this feature of the invention may allow more efficient handling of issues and communication of problems. The geographical location of the group mailbox is subject to change at any time. Of course, the communications plan may allow all members of a node to be informed by electronic mail of an issue where desired rather than simply the person in control of the group mailbox for a node at a particular time. The group mailbox could be simultaneously accessible by multiple persons in multiple locations. Alternatively, the group mailbox could be controlled such that it may only be read and responded to from a single computer at any particular time.

FIG. 3 illustrates a flow chart of a method of communicating in accordance with the invention. The method of communication begins in step 50. At step 52, information is received that is subject to communications in accordance with the invention. Alternatively, an event is experienced wherein the event is an issue on which communications are managed in accordance with the invention. An event may include the passage of time where the issue on which communications is managed comprises the monitoring of status. In step 54, the person receiving the information or experiencing the event may consult criteria associated with a communications plan and communicate the information that is to be communicated to identified persons. For purposes of this patent, a person is deemed to have consulted the criteria even if they have memorized the criteria from previous experience and know the information to be communicated and who the information is to be communicated to from that experience. Also, a person is deemed to have consulted the criteria if they have been instructed by another person as to the criteria, the information to communicate, and the persons to communicate the information to.

In step 56, the person may also take various actions in addition to communication that are called for by the communications plan. This step may be omitted if no actions are identified by the plan or if no action is appropriate based upon the plan. Then, in step 58, the person determines whether communication is required to a higher level, lower level, or across the hierarchy based upon criteria identified in the communications plan or human judgment. In exercising judgment or following the criteria as to whether the information should be communicated to a different group or node within the hierarchy, the communications plan may allow consideration of factors such as the person or persons that may be affected by the issue or information, the number of persons or sites that may be affected by the issue or information, the impact to the enterprise, the impact to a client or customer, the impact to a supplier, the expected resolution time if applicable and/or the potential public relations impact. In the case of status monitoring, the criteria may specify various changes in status or a collection of changes in status that indicate communication of the information should be made to a higher or lower level or across the hierarchy.

If further communication is required, then the relevant information defined by the communications plan is communicated to the appropriate persons in step 60. Where information to be communicated in accordance with the communications plan is not available, a subset of the information may be communicated. Where the person deciding whether to communicate information deems other information not defined in the communications plan to be helpful, that information may also be communicated. The process then ends at step 62. The process illustrated in FIG. 3 may be repeated multiple times by multiple groups within the hierarchy while handling a particular issue or set of issues.

The invention allows efficient collection of information, analysis of information, validation of information, dissemination of information, and status reporting. Issues may be prioritized and escalated in an organized and efficient manner to facilitate faster and more accurate decision making by an enterprise. Although the invention may be used to provide a communications management plan for many different types of issues, examples of particular uses of the invention include the deployment of a new system, the deployment of a new service, response to a crisis, location of relevant expertise within an enterprise, implementation of an enterprise-wide project, implementation of new processes within or external to an enterprise, and the monitoring of the status of a system or the enterprise itself.

Although the present invention has been described in detail, it should be understood that various changes, substitutions and alterations can be made hereto without departing from the sphere and scope of the invention as defined by appended claims.

To aid the Patent Office and any readers of any patent issued on this application in interpreting the claims appended hereto, applicants wish to note that they do not intend any of the appended claims to invoke paragraph 6 of 35 U.S.C. § 112 as it exists on the date of filing hereof unless “means for” or “step for” are used in the particular claim.

What is claimed is:

1. A method for managing an enterprise's communications, comprising:
identifying a plurality of issues on which to manage communications;
for each of the plurality of issues, creating a communications list comprising at least one person that is to be informed of an issue;
for at least one of the plurality of issues, organizing the communications list hierarchically;
for the at least one of the plurality of issues, establishing a first criterion identifying when information about the at least one of the plurality of issues should be communicated to a level higher in the hierarchy of the communications list,
establishing a second criterion identifying when information about the at least one of the plurality of issues should be communicated to a level lower in the hierarchy of the communications list
establishing a third criterion identifying when information about the at least one of the plurality of issues should be communicated across the hierarchy of the communications list.

2. The method of claim 1, further comprising:
for the at least one of the plurality of issues, identifying actions that should be taken in response to the issue.

3. The method of claim 1, further comprising:
for the at least one of the plurality of issues, compiling information representing the at least one of the plurality of issues, the communications list organized hierarchically, and first, second, and third criterion into a tangible medium of expression.

4. The method of claim 1, wherein at least one of the first criterion, second criterion, and third criterion require human judgment as to whether information about the at least one of the plurality of issues should be communicated.

5. The method of claim 1, wherein organizing the communications list hierarchically further comprises:
identifying a plurality of groups comprising at least one member wherein the members of a group comprise one or more persons on the communications list;
organizing the plurality of groups hierarchically.

6. The method of claim 5, wherein the groups are organized in a tree structure.

7. The method of claim 5, wherein each group has an electronic group mailbox associated with it.

8. The method of claim 7, wherein the electronic group mailbox is managed by at least one person with decision making authority for the group.

9. The method of claim 5, wherein items in the group mailbox may be read and responded to from a plurality of computers at a plurality of physical locations.

10. The method of claim 9, wherein items in the group mailbox may only be read and responded to from a single computer at any particular time.

11. The method of claim 1, wherein the plurality of issues comprises a set of issues related to a subject selected from the group consisting of the deployment of a new system, the deployment of a new service, the response to a crisis, the location of expertise, the implementation of an enterprise wide project, and the monitoring of the status of a system.

12. The method of claim 1, wherein the plurality of issues comprises issues of a type selected from the group consisting of issues that must be reported to other persons, issues that do not need to be reported, and issues that need to be reported on a periodic basis.

13. A method of communicating about an issue in an organized fashion, comprising:
receiving a communication about the issue;
making a decision as to whether to communicate information about the issue to a higher level of a hierarchy, a lower level of the hierarchy, or across the hierarchy based upon a set of pre-established criteria;
wherein the pre-established criteria and hierarchy were previously established by
creating a communications list comprising at least one person that is to be informed of the issue,
organizing the communications list hierarchically,
establishing pre-established criteria identifying when information about the at least one of the plurality of issues should be communicated to a higher level in the hierarchy, a lower level of the hierarchy, or across the hierarchy.

14. The method of claim 13, further comprising:
taking actions in response to the issue and a pre-established identification of actions to be taken in response to the issue.

15. The method of claim 13, wherein at least some of the pre-established criteria require human judgment as to whether information about the at least one of the plurality of issues should be communicated.

16. The method of claim 13, wherein the hierarchy comprises a plurality of groups comprising at least one member wherein the members of a group comprise one or more persons on the communications list.

17. The method of claim 16, wherein each group has an electronic group mailbox associated with it.

18. The method of claim 17, wherein the electronic group mailbox is managed by at least one person with decision making authority for the group.

19. The method of claim 13, wherein the issue comprises one issue in a set of issues related to a subject selected from the group consisting of the deployment of a new system, the deployment of a new service, the response to a crisis, the location of expertise, the implementation of an enterprise wide project, and the monitoring of the status of a system.

20. A work of authorship, comprising:
a communication embodied in a tangible medium of expression wherein the communication was generated by
receiving information about an issue;
making a decision to generate the communication about the issue in response to the information and a set of pre-established criteria, the communication generated for purposes of informing at least one of a higher level of a hierarchy, a lower level of the hierarchy, or across the hierarchy;
wherein the pre-established criteria and hierarchy were previously established by
creating a communications list comprising at least one person that is to be informed of the issue,
organizing the communications list hierarchically,
establishing pre-established criteria identifying when information about the at least one of the plurality of issues should be communicated to a higher level in the hierarchy, a lower level of the hierarchy, or across the hierarchy.

21. The work of authorship of claim 20, wherein at least some of the pre-established criteria require human judgment as to whether information about the at least one of the plurality of issues should be communicated.

22. The work of authorship of claim 20, wherein the hierarchy comprises a plurality of groups comprising at least one member wherein the members of a group comprise one or more persons on the communications list.

23. The work of authorship of claim 22, wherein each group has an electronic group mailbox associated with it.
